(19) United States
(12) Patent Application Publication
(10) Pub. No.: US 2026/0230751 A1
(43) Pub. Date: Aug. 6, 2026

(54) Equalization of Impulse Responses for Slot Speakers

(71) Applicant: Samsung Electronics Co., Ltd., Suwon-si (KR)

(72) Inventors: Sunil Ganpat Bharitkar, Stevenson Ranch, CA (US); William Andrew Decanio, Valencia, CA (US)

(21) Appl. No.: 19/363,248

(22) Filed: Oct. 20, 2025

Related U.S. Application Data
(60) Provisional application No. 63/753,378, filed on Feb. 3, 2025.

(51) Int. Cl. H04R 3/04; H04R 1/02; H04R 1/40; H04R 3/12

(52) U.S. Cl. CPC H04R 3/04; H04R 1/028; H04R 1/403; H04R 3/12; H04R 2499/15

(57) ABSTRACT

In one embodiment, a method includes outputting, by a slot speaker, an audio signal x(n) and determining, at each of number of different positions i, an audio signal yᵢ(n) resulting at that position from the output audio signal. The method further includes determining a multi-position equalization filter for the slot speaker by optimizing an equalization filter metric that reflects (1) a difference between an unequalized response at each position and a transient-filter equalized response at each respective position and (2) the number of positions at which the transient-filter equalized response has less artifact energy than the unequalized response.

### PRIORITY CLAIM

This application claims the benefit under 35 U.S.C. § 119 of U.S. Provisional Patent Application No. 63/753,378, filed Feb. 3, 2025, which is incorporated by reference herein.

### TECHNICAL FIELD

This application generally relates to equalization of impulse responses for slot speakers.

### BACKGROUND

Signal processing on consumer devices (e.g., TVs, soundbars, etc.) is used to enhance audio output. Such signal processing includes perceptual bass enhancement, loudspeaker-room equalization, upmixing, spatial rendering with head-related transfer functions (HRTF), etc. Such processing (including factoring loudspeaker-room acoustics) will introduce phase distortion (non-uniform group delay) in the signal chain to the listener. This distortion needs to be modeled and equalized by a digital filter in order to improve the quality of the output audio. In the case of slim form-factor consumer devices such as TVs, acoustic radiation from the transducer may be coupled to the room through a slot or aperture in which the transducer resides.

### BRIEF DESCRIPTION OF THE DRAWINGS

FIG. 1 illustrates an example of a slot speaker.

FIG. 2 illustrates two example audio artifacts often found in slot speakers.

FIG. 3 illustrates an example process for designing an improved filter for a slot speaker.

FIG. 4 illustrates an example of the energy artifacts in an acoustic signal both before and after the primary peak in that signal.

FIG. 5 illustrates an example flowchart providing an example implementation of Algorithm 1.

FIG. 6 illustrates an example computing system.

### DESCRIPTION OF EXAMPLE EMBODIMENTS

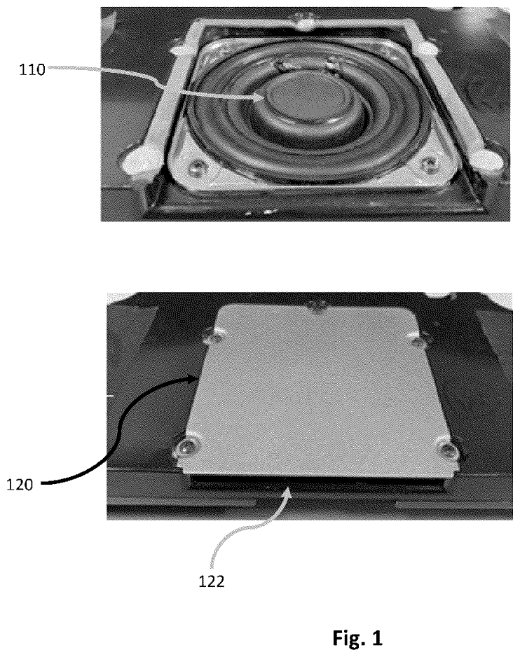

Speakers are sometimes implemented in slim form factors, such as in consumer devices such as in flat screen TVs, where the screen and bezel size are relatively thin. For example, slot speakers may be affixed behind the screen and radiate sound from the sides, top, and bottom of the display screen. When implemented in a slim form factor, acoustic radiation from the speaker transducer is coupled to the room through a slot or aperture in which the transducer resides. Speaker implementations that use such a slim form factor are referred to herein as a “slot speaker.” FIG. 1 illustrates an example of a slot speaker. Speaker 110 is shown without any cover. In a slim form-factor implementation, cover 120 covers speaker 110, and audio produced by speaker 110 is coupled to a room through slot 122 in cover 120. Other slim form factor shapes and configurations exist beyond that shown in FIG. 1.

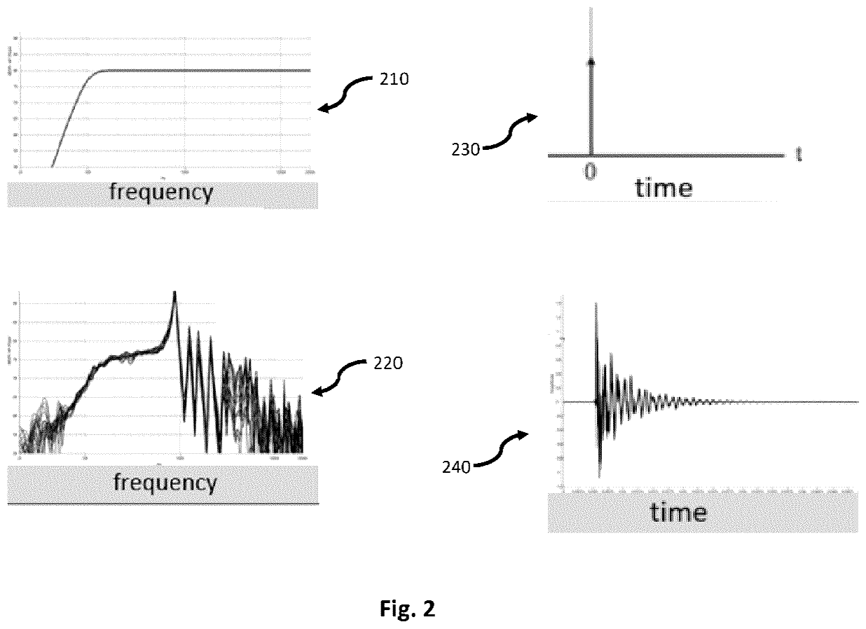

Due to the slim form factor and limited aperture used to couple acoustic energy to the outside environment, slot speakers typically have degraded audio performance relative to non-slot speakers. FIG. 2 illustrates two example audio artifacts often found in slot speakers. Graph 210 illustrates a typical frequency response of a high-quality non-slot speaker, showing the flat frequency response associated with good speaker output. In contrast, the frequency response of a slot speaker is shown in graph 220, which illustrates that that the frequency response of a slot speaker is often not flat, but rather has significant frequency-dependent peaks and valleys. Likewise, graph 230 illustrates an ideal impulse response (in the time domain) of a high-quality speaker. In graph 230 there is an impulse at time t=0, and the impulse-response curve shows no ringing after this impulse. In contrast, graph 240 illustrates an example impulse response of a slot speaker, and shows significant ringing in the time domain after an impulse at time t−0. These degradations are commonly caused by slot speakers, resulting in degraded audio performance.

In addition, the sound dispersion of a slot speaker is not spatially uniform, and as a result, the frequency and impulse response varies as a function of position relative to the slot speaker. For example, the sound dispersion of a slot speaker typically is very wide in the plane along the narrow dimension of the slot, but tends to become narrow on the plane along the larger dimension of the slot, and this effect is often even more pronounced at relatively higher frequencies.

A digital filter is often used with a speaker, including slot speakers, in order to improve the output audio signal. If a speaker outputs an audio signal x(n), then the audio output measured at position i is yᵢ(n). Here, the output is position dependent because the acoustic signal itself is position-dependent, as described above. As illustrated in FIG. 2, an ideal speaker outputs an ideal impulse response as shown in graph 230, without the ringing shown in graph 240. Thus, at position i, the filter w(n) for a speaker ideally convolves with the impulse response of the speaker hᵢ(n) to result in the Dirac delta function at every position i. In mathematical terms, ideally:

$$w ( n ) ⊙ {h}_{i} ( n ) = δ ( n ) ; ∀ i$$

Thus, the closer the filtered signal w(n)\textcircled{*}hᵢ(n) is to δ(n) for all positions i, the better the filter w(n).

Designing a filter w(n) is a complex process that typically does not have an analytic solution, for non-minimum phase systems, and therefore it is not clear what the ideal filter is for a given speaker, nor is it easy to design and evaluate a given filter for a particular speaker, as many different approaches and options exist. For example, an ideal filter may be approximated by chaining together s number n-order filters, but it is not clear how many filters to use (i.e., how big s should be) or what order n each filter should be, or how much delay in samples the filter needs to be delayed by to approximate the Dirac delta function for a non-minimum phase system.

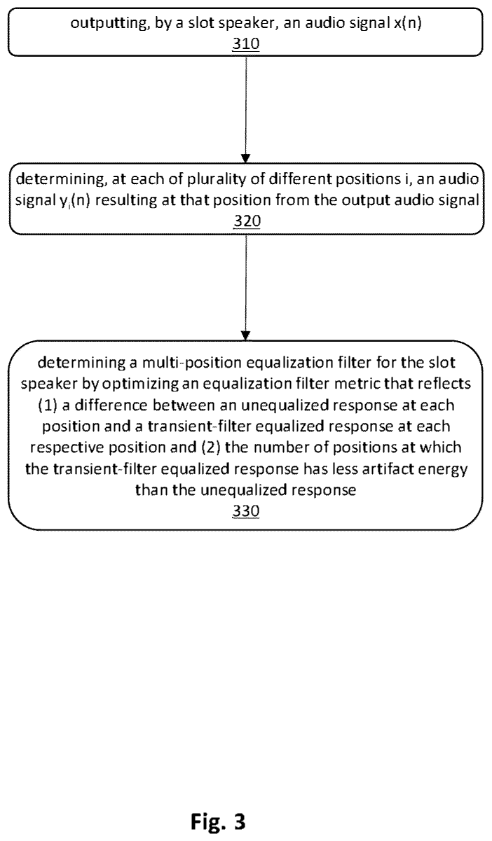

FIG. 3 illustrates an example process for designing an improved filter for a slot speaker. While the example of FIG. 3 applies the process described herein to slot speakers in particular, in general these techniques can be used to design a filter for any loudspeaker. Step 310 of the example method of FIG. 3 includes outputting, by a slot speaker, an audio signal x(n). The audio signal may be a real audio signal or a simulated audio signal, based on the slot speakers audio parameters. In particular embodiments, steps 310-320 may be performed in real or simulated anechoic chamber.

Step 320 of the example method of FIG. 3 includes determining, at each of multiple different positions i, an audio signal yᵢ(n) resulting at that position from the output audio signal. In other words, step 320 includes determining the audio signal at position yᵢ(n) for each of multiple positions i, where the determined audio signal results from the output audio signal x(n) from the slot speaker. As described above, in particular embodiments the audio output may be real (e.g., as determined by a microphone) or may be simulated measurements at each position. In particular embodiments, the positions may include multiple measurement positions in the horizontal plane and in the vertical plane with respect to the slot in the slot speaker. Particular embodiments may ensure that the signals are time aligned so that the impulse responses are aligned, e.g., on a hemispherical dome.

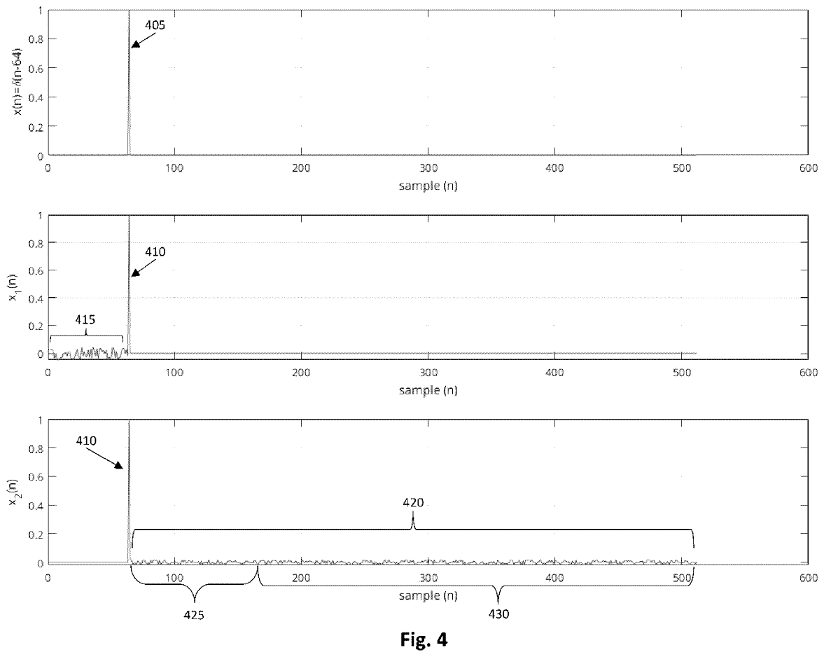

Step 330 of the example method of FIG. 3 includes determining a multi-position equalization filter for the slot speaker by optimizing an equalization filter metric that reflects (1) a difference between an unequalized response at each position and a transient filter equalized response at each respective position and (2) the number of positions at which the transient-filter equalized response has less artifact energy than the unequalized response. Here, the equalization filter metric characterizes the time-domain performance of a filter over multiple-positions, with the goal being that the filtered time-domain signal should be as close as possible to a delta function at every position. As described above, in reality a time-domain signal will have artifacts both before (e.g., due to delay imposed by the filter design) and after a primary impulse (i.e., a primary peak). FIG. 4 illustrates an example of the energy artifacts in an acoustic signal both before and after the primary peak in that signal. Peak 405 illustrates an ideal impulse response, with very little acoustic energy both before and after peak 405. In reality, audio from a slot speaker typically has a peak 410 with pre-echo energy 415 occurring before peak 410 and reflection energy 420 occurring after peak 410. These pre-peak and post-peak artifacts reduce audio quality, and an ideal filter would eliminate those artifacts.

In addition, a metric such as mean-square error with respect to a delta function can be used to evaluate the performance of a filter using the time domain signals in FIG. 4, but such metrics treat both pre-peak and post-peak energy the same, while in reality different aspects of those energies have different effects on audio quality, as descried below.

As described above, filtering can introduce pre- and post-echoes in the equalized responses. These arise due to several factors, including (i) mismatch between the impulse responses at two different positions (e.g., a mixed-phase filter designed in one position but applied to another position), (ii) truncation effects on the all-pass components due to constraining the length of the FIR filter, and (iii) equalizing high Q notches. In particular embodiments, the equalization filter metric of FIG. 3 accounts for the energy in the (a) pre-echoes, (b) post-echoes (which, in particular embodiments, include both early and late energy of the reflections), and (c) a measure of the decay rate of the impulse response. In particular embodiment, these terms are linearly weighted with different weightings to obtain a trade-off in the impulse responses during equalization filter synthesis. The first part of the temporal metric as a measure of performance at a single position m, for a unit-amplitude normalized response h^{m}(n), is expressed as,

$$τ ( m ) = {α}_{1} ‖ {h}_{pre}^{( m )} ( n ) ‖ + {α}_{2} ‖ {h}_{early}^{( m )} ‖ + {α}_{3} ‖ {h}_{late}^{( m )} ‖ + {α}_{4} {a}^{( m )} / {b}^{( m )} \qquad ( )$$

where the pre-echo energy is computed from sample n=0 through sample n=K with |h(K)|≤T, the energy in the early part of the response is computed from n=K+1 through n=M. The late energy is computed from n=M+1 through the end of the response. The values of a and b are the y-intercept and the decay rate of an exponential fit ae^{-bx} to the impulse response |h^{m}(n)|. The faster the decay, the lower the value of a/b, hence a lower τ(m) compared to a slower decay impulse response with a higher τ(m).

For instance, a particular embodiment of an equalization filter metric for a filter that is based on position m, iteration L, and delay Δ can be represented as follows. First, an unequalized response with delay Δ can be represented as:

$${q}_{Δ}^{( m )} ( n ) = {\text{?}}^{- 1} \{ {H}_{m} ( k ) {e}^{- j ( \frac{2 π}{N} ) kn Δ} \} , ∀ m ;$$

$$\text{?} \text{indicates text missing or illegible when filed}$$

And the transient filter equalized response designed from the response at position m, a delay Δ, an iteration limit L, and an impulse-response candidate prototype i (where i runs from 1 to M) can be represented as:

$${f}_{i , Δ , L}^{( m )} ( n ) = {w}_{i , Δ , L}^{( P )} ( n ) ⊗ {h}_{m} ( n ) , ∀ m ; \qquad ( 3 )$$

Then, a temporal metric κΔ(m) is computed for each position with a delay Δ. Similarly, a metric Ø_{i,Δ,L}(m) is computed with the equalization filter

$${w}_{i , Δ , L}^{( P )} ( n )$$

for each position and each prototype hᵢ(n){i=1, . . . , M}. The metric computes energies in the pre-echoes, early and later part of the responses (denoted as “pre”, “early”, “late”)

$$\begin{matrix}{𝔎}_{Δ} ( m ) = {α}_{1} {‖ {q}_{Δ}^{( m )} ( n ) ‖}^{pre} + {α}_{2} {‖ {q}_{Δ}^{( m )} ( n ) ‖}^{early} + {α}_{3} {‖ {q}_{Δ}^{( m )} ( n ) ‖}^{late} + {α}_{4} {a}_{Δ}^{( m )} / {b}_{Δ}^{( m )} \\ {∅}_{i , Δ , L} ( m ) = {α}_{1} {‖ {f}_{i , Δ , L}^{( m )} ( n ) ‖}^{pre} + {α}_{2} {‖ {f}_{i , Δ , L}^{( m )} ( n ) ‖}^{early} + {α}_{3} {‖ {f}_{i , Δ , L}^{( m )} ( n ) ‖}^{late} + {α}_{4} {c}_{i , Δ , L}^{( m )} / {d}_{i , Δ , L}^{( m )}\end{matrix} \qquad ( 4 )$$

As a result, these techniques separately account for (1) the energy over a window before the first dominant peak (where less energy is better, i.e., more closely models a delta function) (2) the energy over a window a number of samples immediately after the dominant peak (n=K+1) and (n=Q) samples (where less energy is better), (3) the energy over a window from n=Q+1 to end of the IR (where less energy is better), and exponential fit parameters a measure of shortening of impulse response. In addition, these techniques account for the energy in an unequalized vs equalized (filtered) signal at multiple different spatial positions m.

A difference in energies, βₘ defined below in the various parts of the unequalized and equalized impulse response is then computed and sent through a sign function and summed to determine the number of positions where the equalized responses outperform the unequalized responses (in this example, expressed as λ_{i,Δ,L}). Finally, λ is scaled by the sum of values conditioned where the equalized result is better

$$( {\sum }_{m = 1}^{M} {β}_{m \vert sgn ( {β}_{m} ) = 1} )$$

to yield a composite multiposition measure ψ_{i,Δ,L}. Thus, the higher the number of positions as characterized by λ and the greater the value β (in which equalized responses are better), the higher this measure. In the extreme when βₘ<0, ∀m→λ=0<, whereas when βₘ≥0, ∀m→λ=M. Accordingly, maximizing ψ_{i,Δ,L}≥0 in yields the optimal values of {i*Δ*L*}.

$${β}_{m =} ( {𝔎}_{Δ} ( m ) - {∅}_{i , Δ , L} ( m ) ) \qquad ( 5 )$$

Where βₘ represents the differences in energies at various portions of the acoustic signal, and a greater βₘ is relatively better. Then:

$${λ}_{i , Δ , L} = {\sum }_{m = 1}^{M} ( \frac{1}{2} + \frac{1}{2} sgn ( {β}_{m} ) ) \qquad ( 6 )$$

determines how many positions the filter performs well (no positions=0, all positions=M), and:

$$sgn ( x ) = \{ \begin{matrix}1 & if x \geq 0 \\ - 1 & otherwise\end{matrix} \qquad ( 7 )$$

$${ψ}_{i , Δ , L} = {λ}_{i , Δ , L} ( {\sum }_{m = 1}^{M} ( {β}_{m} {\vert}_{sgn ( {β}_{m} ) = 1} ) \qquad ( 8 )$$

$${max}_{i , Δ , L} {ψ}_{i , Δ , L} \to ( {i}^{*} , {Δ}^{*} , {L}^{*} ) \qquad ( 9 )$$

where ψ_{i,Δ,L} multiplies the scores represented by βₘ with the corresponding counts for a given filter design based on λ. In this example, maximizing ψ determines the best filter that reduces the energies in pre-ring, early/late, and shortens (exponential fit ratio) over all positions m, improving the audio output of the slot speaker.

In particular embodiments, different transducers within a slot speaker (e.g., a woofer speaker and a mid-range speaker) may each have their own associated metric ψ and the final ψ may be a combination (e.g., a weighted sum) of each tranducer's ψ. In particular embodiments, different positions m may be weighted differently in the metric ψ. For example, horizontal and vertical positions within the narrow dispersion of the slot speaker could be weighted more than spatial outlier positions.

Rather than use an iterative approach as described with respect to the example of Algorithm 1, below, particular embodiments may instead use a multi-position equalization filter of order P and delay Δ which is computationally lighter weight and introduces low sample Δ. For example, such a metric may be based on a least-squares impulse-response matrix, where the least-squares solution leverages the Toeplitz structure of the impulse response matrix that represents the impulse responses measured at all positions. For instance, for a given i (corresponding to location i), the impulse response matrix is Hᵢ (where impulse responses are length N in duration), the desired response is:

$${\underline{d}}_{i} = {( 0 , 0 , … , 1 , 0 , 0 , … )}^{T} , {\underline{w}}_{i} is the filter of order P , {\underline{d}}_{i} ∈ {ℜ}^{N \times 1} \qquad ( 10 )$$

where the unity “1” in dᵢ is an impulse at the position corresponding to the delay Δ to be determined. Then:

$${\underline{d}}_{i} = {\underline{H}}_{i} {\underline{w}}_{i} \qquad ( 11 )$$

which, solving for wᵢ, results in:

$${\underline{w}}_{i} = {( {\underline{H}}_{i}^{T} {\underline{H}}_{i} + ϱ I )}^{- 1} {\underline{H}}_{i}^{T} {\underline{d}}_{i} \qquad ( 12 )$$

Where the matrix Hᵢ is represented by:

$${\underline{H}}_{i} = [ \begin{matrix}{h}_{i} ( 0 ) & 0 & 0 & {0}_{1 \times ( M - 3 )}^{T} \\ {h}_{i} ( 1 ) & {h}_{i} ( 0 ) & 0 & {0}_{1 \times ( M - 3 )}^{T} \\ {h}_{i} ( 2 ) & {h}_{i} ( 1 ) & {h}_{i} ( 0 ) & {0}_{1 \times ( M - 3 )}^{T} \\ … & … & … & … \\ {h}_{i} ( N - 1 ) & {h}_{i} ( N - 2 ) & {h}_{i} ( N - 3 ) & {h}_{i} ( 0 )\end{matrix} ] \qquad ( 13 )$$

Matrix Hᵢ is a non-symmetric Toeplitz matrix, which is efficient for multiplication of matrix with vectors, for example using fast-Fourier transform techniques.

Filter wᵢ in Eqn. (12) is an example for single position i. For multiple positions,

$$\underline{d} = \underline{Hw} \qquad ( 14 )$$

$$\underline{w} = {( {\underline{H}}^{T} \underline{H} + ϱ I )}^{- 1} {\underline{H}}^{T} \underline{d} \qquad ( 15 )$$

$$\underline{d} = {( {\underline{d}}_{1} , {\underline{d}}_{2} , … , {\underline{d}}_{M} )}^{T} \qquad ( 16 )$$

$$\underline{H} = [ \begin{matrix}{\underline{H}}_{1} \\ {\underline{H}}_{2} \\ … \\ {\underline{H}}_{M}\end{matrix} ] \qquad ( 17 )$$

In particular embodiments, the regularization parameter ρ may be set as a constant empirically to ensure stable inverse, or it may be a hyper-parameter for optimization using constrained optimization, particle-swarm optimization, Bayesian optimization, or other search techniques. Delay A may be determined using, e.g., a brute-force search from 1 through 10 samples and filter that maximizes the metric ψ is selected as the multi-position transient suppression filter. Here, ψ is modified relative to Eqn. (8) in that there is no iteration value L and no candidate prototype i, and therefore ψ is a function of A for a given position m. Thus, at each position m, Δ will run through its initial value through its final value (e.g., Δ=10). Δ=1 corresponds to dᵢ=(1, 0, . . . , 0, 0, 0, . . . )^{T}, Δ=2 corresponds to dᵢ=(0, 1, . . . , 0, 0, 0, . . . )^{T}, and so on. The filter w is the filter that maximizes the value of 4 across the positions.

Other embodiments may construction a mixed-phase equalization filter based on an iteration L, a prototype iteration i, and a delay Δ. For example, determining a multi-position mixed-phase equalization filter may include executing a multi-position transient response slot equalization algorithm, i.e., Algorithm 1, which is described in more detail below. The algorithm assesses each slot impulse response, hᵢ(n) in the measurement set (for a given horizontal or vertical plane) as a prototype candidate for generating a time-domain filter

$${w}_{i , Δ , L}^{( P )} ( n )$$

with order P. This algorithm uses (i) an incremental search for the optimal number of iterations L to use in iterative decomposition for minimum-phase and a causal all-pass filter and (ii) an incremental search for the delay (Δ) applied to the inverted all-pass filter. The algorithm incorporates a weighted temporal metric to identify the optimal delay Δ* and iteration L* for the filter generated from the given prototype candidate hᵢ(n). The metric determines the quality of improvement (or degradation) by first computing the difference between the energies in various parts of the original response (hₘ(n)) and the equalized responses

$${w}_{i , Δ , L}^{( P )} ( n ) ⊗ {h}_{m} ( n )$$

for all positions m∈{1, 2, . . . , M}. The process is repeated over all candidate prototypes hⱼ(n) with 1≤j≤M), and the best filter

$${w}_{{i}^{*} , {Δ}^{*} , {L}^{*}}^{( P )} ( n )$$

is selected that maximizes the metric.

The core parameters that determine the equalization filter

$${w}_{i , Δ , L}^{( P )} ( n )$$

for a given prototype hᵢ(n) include the iterative decomposition parameter L and the filter delay Δ. Consequently, a guided search employing a weighted temporal metric determines these parameters for a given prototype. Algorithm 1 describes the technique, where an impulse response hᵢ(n) in the measurement set hₘ(n), m={1, . . . , M} is selected as a prototype candidate. For a given number of iterations, L for iterative decomposition (1) is used to obtain the minimum phase filter

$${G}_{mp , i}^{L} ( k )$$

and the all-pass component

$${H}_{i}^{( L + 1 )} ( k )$$

in the frequency bin k. A candidate filter is generated for a given delay Δ and iteration L (line 9 in Algorithm 1, below) by delaying the all-pass component by Δ after the conjugation operation. The measurements are delayed equally by Δ

$$( viz . , {q}_{Δ}^{( m )} ( n ) ,$$

line 10) to time-align with the equalized response

$${f}_{i , Δ , L}^{( m )} ( n )$$

(line 11) before using the metric (line 12) to determine the quality of the filter. The optimal filter is then determined (line 20) after evaluating all prototypes with the sequential combinations of L and Δ. The multi-position transient response slot equalization Algorithm 1 is as follows:

Algorithm 1: Multi-position transient response equalization
$Result : Filter {w}_{{i}^{*} , {Δ}^{*} , {L}^{*}}^{( P )} ( n ) optimized and Δ , L and i - th prototype IR of order P$

| 1 | Initialize: Select i = 1, IR hᵢ(n) candidate prototype i ∈ {1, . . . , M} with M measurement | | | |
|---|---|---|---|---|
| | points m = {1, . . . , M}, set L ∈ {1, . . . , L^{up}} (number of iterations for iterative decomposition); | | | |
| 2 | while i ≤ M do | | | |
| 3 | \| | Select i-th candidate prototype IR hᵢ(n), L = 1; | | |
| 4 | \| | while L ≤ L^{up} do | | |
| 5 | \| | \| | $Use iterative decompsition to compute minimum - phase inversion {G}_{mp , i}^{L} ( k ) = 1 / [ {H}_{mp , i}^{( 0 )} ( k ) {H}_{mp , i}^{( I )} ( k ) … {H}_{mp , i}^{( L - 1 )} ( k ) ]$ | |
| | \| | \| | $and all - pass filter {H}_{i}^{( L + 1 )} ( k ) ;$ | |
| 6 | \| | \| | Δ = 1; | |
| 7 | \| | \| | while Δ ≤ P/2 do | |
| 8 | \| | \| | \| | With * denoting complex conjugation, and ⊗denoting linear convolution; |
| 9 | \| | \| | \| | ${w}_{i , Δ , L}^{( P )} ( n ) = {\text{?}}^{- 1} \{ {G}_{mp , i}^{( L )} ( k ) {H}_{i}^{* ( L + 1 )} ( k ) {e}^{- j ( \frac{2 π}{N} ) k n Δ} \} ;$ |
| 10 | \| | \| | \| | ${q}_{Δ}^{( m )} ( n ) = {\text{?}}^{- 1} \{ {H}_{m} ( k ) {e}^{- j ( \frac{2 π}{N} ) k n Δ} \} , ∀ m ;$ |
| 11 | \| | \| | \| | ${f}_{i , Δ , L}^{( m )} ( n ) = {w}_{i , Δ , L}^{( P )} ( n ) ⊗ {h}_{m} ( n ) , ∀ m ;$ |
| 12 | \| | \| | \| | Compute [symbol] _{Δ}(m) and ∅_{i,Δ,L} (m); ∀m using (4); |
| 13 | \| | \| | \| | Δ = Δ + 1; |

| | | | |
|---|---|---|---|
| 14 | \| | \| | end |
| 15 | \| | \| | L = L + 1; |

| | | |
|---|---|---|
| 16 | \| | end |
| 17 | \| | Compute (8) |
| 18 | \| | i = i + 1; |

| | |
|---|---|
| 19 | end |
| 20 | $Per ( 9 ) , select {w}_{{i}^{*} , {Δ}^{*} , {L}^{*}}^{( P )} ( n ) that maximizes ( 8 )$ |

The iterative decomposition referenced in line 5 involves iterating Eqns. (22a)-(22c) in a loop while r≤L.

$${H}_{i} ( k ) = \text{?} \{ {h}_{i} ( n ) \} = {\sum }_{n = 0}^{N - 1} {h}_{i} ( n ) {e}^{- j ( \frac{2 π}{N} ) kn} \qquad ( 18 )$$

$$\text{?} \text{indicates text missing or illegible when filed}$$

$${\hat{h}}_{e , i} ( n ) = \frac{1}{N} {\sum }_{k = 0}^{N - 1} log \vert {H}_{i} ( k ) \vert {e}^{j ( \frac{2 π}{N} ) kn} \qquad ( 19 )$$

$${\hat{h}}_{mp , i} ( n ) = \{ \begin{matrix}{\hat{h}}_{e , i} ( n ) , & n = 0 , N / 2 \\ 2 {\hat{h}}_{e , i} ( n ) , & 1 \leq n < N / 2 \\ 0 & N / 2 < n \leq N - 1\end{matrix} \qquad ( 20 )$$

$${\hat{H}}_{mp , i} ( k ) = DFT \{ {\hat{h}}_{mp , i} ( n ) \} \qquad ( 21 )$$

$${\hat{H}}_{mp , i}^{( r )} ( k ) = \frac{{\hat{H}}_{mp , i} ( k )}{{2}^{r + 1}} ; \qquad ( 22 a )$$

$${H}_{mp , i}^{( r )} ( k ) = exp [ {\hat{H}}_{mp , i}^{( r )} ( k ) ] \qquad ( 22 b )$$

$${H}_{i}^{( r + 1 )} ( k ) = {H}_{i}^{( r )} ( k ) / {H}_{mp , i}^{( r )} ( k ) \qquad ( 22 c )$$

$${H}_{i}^{( 0 )} ( k ) = {H}_{i} ( k ) \qquad ( 23 )$$

Algorithm 1 includes selecting each of the measured responses (line 3) and using it compute a minimum-phase inverse (line 5) and an approximate all-pass delayed inverse (conjugation and delay Δ, through line 9) through iteration L. Algorithm 1 includes designing the filter for response i, iteration L and delay Δ (line 9), and then computing the new equalization metric (lines 10-12 and 17). Finally, the algorithm includes selecting the filter that maximizes the metric (line 20)

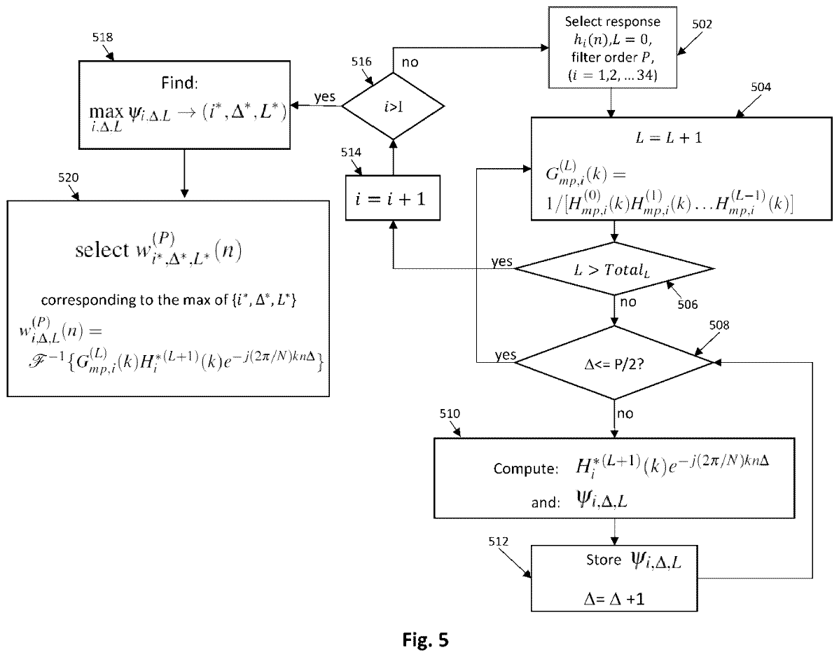

FIG. 5 illustrates an example flowchart providing an example implementation of Algorithm 1. For example, step 502 includes initializing the parameters i and L, as in line 1 of Algorithm 1. L is iterated in step 504, and step 506 determines whether the value of L exceeds the total number of allowable iterations. If not, then step 508 determines whether Δ is greater than P/2, in this example. If not, then step 510 includes determining the corresponding filter and value of the equalization metric ψ, and then step 512 includes iterating A. Steps 508-512 repeat until Δ is greater than P/2, and then step 504 repeats. Once the total number of allowable iterations is reached in step 506, then i is iterated at step 514, and after checking whether each prototype i has been evaluated, the process of FIG. 5 either returns to step 502 or determines the maximum ψ at step 518. Then, step 520 includes selecting the filter w(n) corresponding to maximum value of i, which as described above, is the filter that provides the best signal quality at each evaluated position for the slot speaker being evaluated.

The approach of Algorithm 1 may not be as lightweight as the matrix-inversion approach described above, as Algorithm 1 occurs for a number of iterations L of min-phase/all-pass decomposition, brute-force search over delay Δ, and search over each of the measured impulse responses that could be a prototype for designing this filter.

After selecting the appropriate filter, then this filter may be implemented by the device controlling the slot speaker, e.g., each designed digital filter may be provided and implemented by computer hardware in a TV for those slot speaker(s) in that TV.

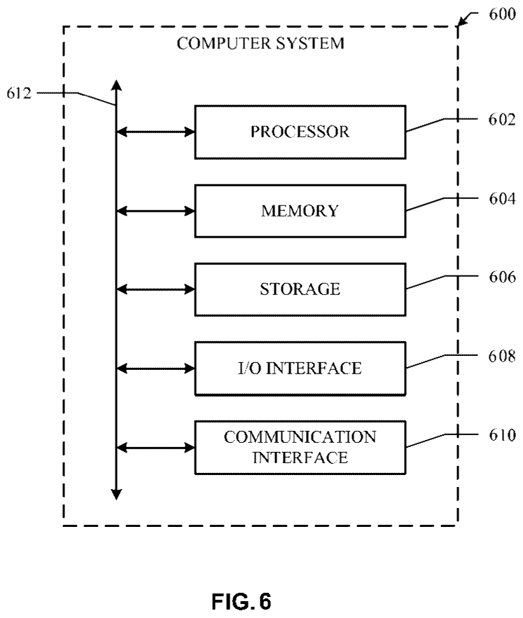

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure contemplates a system that includes one or more non-transitory computer readable storage media storing instructions; and one or more processors coupled to the one or more non-transitory computer readable storage media and operable to execute the instructions to perform certain functions includes embodiments in which those functions are performed by a single processor, embodiments in which those functions are performed by multiple processors that each perform all the functions, and embodiments in which those functions are performed by multiple processors (e.g., in separate computing devices) where each processor performs at least one function but less than all recited functions.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. A method comprising:
outputting, by a slot speaker, an audio signal x(n);
determining, at each of plurality of different positions i, an audio signal yᵢ(n) resulting at that position from the output audio signal;
determining a multi-position equalization filter for the slot speaker by optimizing an equalization filter metric that reflects (1) a difference between an unequalized response at each position and a transient-filter equalized response at each respective position and (2) the number of positions at which the transient-filter equalized response has less artifact energy than the unequalized response.

2. The method of claim 1, wherein the slot speaker is affixed to a TV.

3. The method of claim 2, wherein the slot speaker is one of a plurality of slot speakers, and the method further comprises performing the steps of claim 1 for each of the plurality of slot speakers.

4. The method of claim 1, wherein the difference between the unequalized response at each position and the transient-filter equalized response at each respective position is based on a difference in (1) pre-echo energy in the audio signal (2) reflection energy in the audio signal and (3) a decay rate of the audio signal after a dominant peak in the audio signal.

5. The method of claim 4, wherein the reflection energy comprises an energy in an initial part of the response after the dominant peak and an energy from an end of the initial part of the response to the end of the response.

6. The method of claim 1, wherein determining the multi-position equalization filter further comprises optimizing the equalization filter metric based on a delay Δ.

7. The method of claim 1, wherein determining the multi-position equalization filter further comprises determining a multi-position equalization filter of order P by optimizing the equalization filter metric based on a least-squares impulse-response matrix.

8. The method of claim 1, wherein determining the multi-position equalization filter further comprises determining a multi-position mixed-phase equalization filter of order P by optimizing the equalization filter metric based on a minimum-phase inversion and an all-pass delayed inverse.

9. The method of claim 8, wherein determining the multi-position mixed-phase equalization filter further comprises executing a multi-position transient response slot equalization algorithm.

10. A system comprising an electronic device comprising: one or more non-transitory computer readable storage media storing instructions; and one or more processors coupled to the one or more non-transitory computer readable storage media and operable to execute the instructions to:
output, by a slot speaker, an audio signal x(n);
determine, at each of plurality of different positions i, an audio signal yᵢ(n) resulting at that position from the output audio signal;
determine a multi-position equalization filter for the slot speaker by optimizing an equalization filter metric that reflects (1) a difference between an unequalized response at each position and a transient-filter equalized response at each respective position and (2) the number of positions at the which transient-filter equalized response has less artifact energy than the unequalized response.

11. The system of claim 10, wherein the slot speaker is affixed to a TV.

12. The system of claim 11, wherein the slot speaker is one of a plurality of slot speakers, and the method further comprises performing the steps of claim 1 for each of the plurality of slot speakers.

13. The system of claim 10, wherein the difference between the unequalized response at each position and the transient-filter equalized response at each respective position is based on a difference in (1) pre-echo energy in the audio signal (2) reflection energy in the audio signal and (3) a decay rate of the audio signal after a dominant peak in the audio signal.

14. The system of claim 13, wherein the reflection energy comprises an energy in an initial part of the response after the dominant peak and an energy from an end of the initial part of the response to the end of the response.

15. The system of claim 10, wherein determining the multi-position equalization filter further comprises optimizing the equalization filter metric based on a delay Δ.

16. The system of claim 10, wherein determining the multi-position equalization filter further comprises determining a multi-position equalization filter of order P by optimizing the equalization filter metric based on a least-squares impulse-response matrix.

17. The system of claim 10, wherein determining the multi-position equalization filter further comprises determining a multi-position mixed-phase equalization filter of order P by optimizing the equalization filter metric based on a minimum-phase inversion and an all-pass delayed inverse.

18. The system of claim 18, wherein determining the multi-position mixed-phase equalization filter further comprises executing a multi-position transient response slot equalization algorithm.

19. One or more non-transitory computer-readable storage media storing instructions that are operable when executed by one or more processors to:
output, by a slot speaker, an audio signal x(n);
determine, at each of plurality of different positions i, an audio signal yᵢ(n) resulting at that position from the output audio signal;
determine a multi-position equalization filter for the slot speaker by optimizing an equalization filter metric that reflects (1) a difference between an unequalized response at each position and a transient-filter equalized response at each respective position and (2) the number of positions at the which transient-filter equalized response has less artifact energy than the unequalized response.

20. The media of claim 19, wherein the difference between the unequalized response at each position and the transient-filter equalized response at each respective position is based on a difference in (1) pre-echo energy in the audio signal (2) reflection energy in the audio signal and (3) a decay rate of the audio signal after a dominant peak in the audio signal.
